(19) United States
(12) Patent Application Publication
(10) Pub. No.: US 2014/0144820 A1
(43) Pub. Date: May 29, 2014

(54) RAPID DEPLOYABLE PACKAGED WASTEWATER TREATMENT SYSTEM

(71) Applicants: DANIEL M. EARLY, NEW CASTLE, VA (US); SCOTT F. EASTER, HUDDLESTON, VA (US)

(72) Inventors: DANIEL M. EARLY, NEW CASTLE, VA (US); SCOTT F. EASTER, HUDDLESTON, VA (US)

(21) Appl. No.: 14/093,298

(22) Filed: Nov. 29, 2013

Related U.S. Application Data
(60) Provisional application No. 61/730,864, filed on Nov. 28, 2012.

(51) Int. Cl. C02F 3/12

(52) U.S. Cl. CPC C02F 3/1236
USPC 210/96.1; 210/264; 210/251; 210/220; 210/197

(57) ABSTRACT

The rapid deployable packaged wastewater treatment system is a low-energy demanding, portable, rapidly deployable and operational wastewater treatment system utilizing a plastic vessel including an aerobic pretreatment and screening chamber that feeds wastewater to a moving bed biological reactor (MBBR) chamber. Immediately downstream from the MBBR bioreactor is a secondary clarifier, which feeds a media polishing filtration system. The media polishing filtration system then passes the treated water to a UV disinfection system. The entire fully functional system, including the plastic vessel and control room, is self-contained in a military-approved TRICON container. A Programmable Logic Controller (PLC) provides automated control of the system and monitors water levels, wastewater characteristics and system components. The container has access doors to the wastewater treatment control room.

### CROSS-REFERENCE TO RELATED APPLICATION

This application claims the benefit of U.S. Provisional Patent Application Ser. No. 61/730,864, filed Nov. 28, 2012.

### BACKGROUND OF THE INVENTION

1. Field of the Invention

The present invention relates to water supply treatment systems, and particularly to a rapid deployable packaged wastewater treatment system that removes biodegradable fats, oil, grease, solids, organic contaminants, nutrients, pathogens and the like from wastewater generated in the field and other mobile locations.

2. Description of the Related Art

In order to support remote military exercises, training and combat operations in remote areas, the armed services typically requires portable wastewater treatment systems that can be rapidly deployed and quickly operational. This need is also true for humanitarian and disaster relief efforts. The discharge of untreated wastewater is not suitable, since it gives rise to numerous environmental concerns, such as the pollution of surface and groundwater resources. Untreated wastewater also contains a number of disease pathogens that are extremely harmful to humans. For example, untreated wastewater is one of the leading causes of dysentery, which can be life threatening. Thus, if a significant amount of untreated wastewater is discharged into a body of water, that body of water will become unavailable for human consumption.

In an expeditionary or disaster relief situation it is impractical to treat wastewater in a conventional manner via collection and transportation through a series of underground pipes to a large, centralized wastewater treatment plant. However, as noted above, the treatment of the wastewater in these conditions is imperative for human health and safety. Existing portable wastewater treatment systems are available. However, the existing systems utilize standard 20- and 40-foot cargo containers and are too large in physical size for many applications. For example, small expeditionary military units ship entire forward operating bases in only Tricon containers and do not have the ability to ship larger containers. The Tricon containers provide the ability to pack and ship systems without the need for specialized loading or unloading mechanisms or equipment. The military requires systems that can treat up to 3,000 gallons per day of wastewater that can be rapidly started and operational and that can be run utilizing the alternative energy sources of wind and solar power or battery stored energy there from with all of the necessary equipment shipped within the individual Tricon container. Furthermore, the military requires systems that utilize minimal energy as their generator derived power is limited.

Thus, it would be desirable to provide a low energy demanding portable containerized water treatment system that is rapidly deployable, started and operational within an individual Tricon container. It would be desirable to provide a mobile containerized water treatment system that can be run solely on alternative energy sources or battery stored energy there from with all of the necessary equipment shipped within the Tricon container. Thus, a rapid deployable packaged wastewater treatment system solving the aforementioned problems is desired.

### SUMMARY OF THE INVENTION

The rapid deployable packaged wastewater treatment system is a low energy demanding, portable, rapidly deployable and operational wastewater treatment system utilizing a plastic vessel including an aerobic pretreatment and screening/primary clarifier chamber that feeds wastewater to a moving bed biological reactor (MBBR) chamber. Immediately downstream from the MBBR bioreactor is a secondary clarifier, which feeds a media polishing filtration system. The media polishing filtration system then passes the treated water to an ultraviolet (UV) disinfection system. The entire fully functional system, including the plastic vessel and control room, is self-contained in a military approved TRICON container.

A Programmable Logic Controller (PLC) provides automated control of the system and monitors water levels, wastewater characteristics and system components. The TRICON container has access doors to the wastewater treatment control room. The roof portion of the TRICON container has an access hatch to access the wastewater treatment vessel. The system is equipped with onboard reusable energy sources, such as solar panels and wind turbines.

These and other features of the present invention will become readily apparent upon further review of the following specification and drawings.

### BRIEF DESCRIPTION OF THE DRAWINGS

FIG. 1 is a top plan view of a rapid deployable packaged wastewater treatment system according to the present invention, shown with the container hatches open.

FIG. 2 is a section view along lines 2-2 of FIG. 1.

FIG. 3 is a section view along lines 3-3 of FIG. 1.

FIG. 4 is a section view along lines 4-4 of FIG. 1.

FIG. 5 is a section view along lines 5-5 of FIG. 1.

FIG. 6 is a top plan view in section of an alternative embodiment of a rapid deployable packaged wastewater treatment system according to the present invention.

FIG. 7 is a perspective view of the rapid deployable packaged wastewater treatment system.

FIG. 8 is a block diagram of a rapid deployable packaged wastewater treatment system according to the present invention.

FIG. 9 is a block diagram of an alternative embodiment of a rapid deployable packaged wastewater treatment system according to the present invention.

Similar reference characters denote corresponding features consistently throughout the attached drawings.

### DETAILED DESCRIPTION OF THE PREFERRED EMBODIMENTS

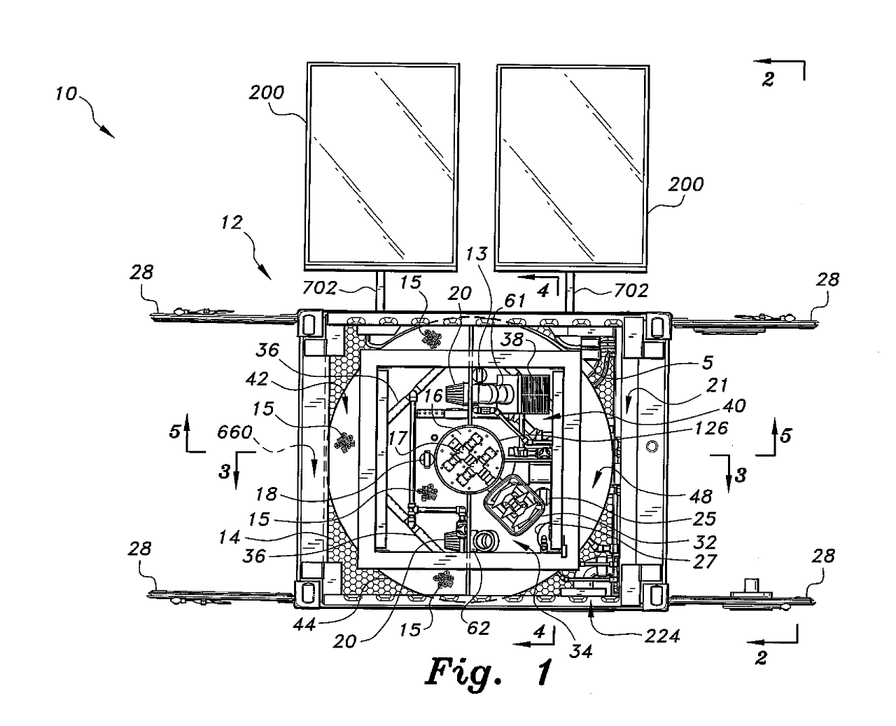

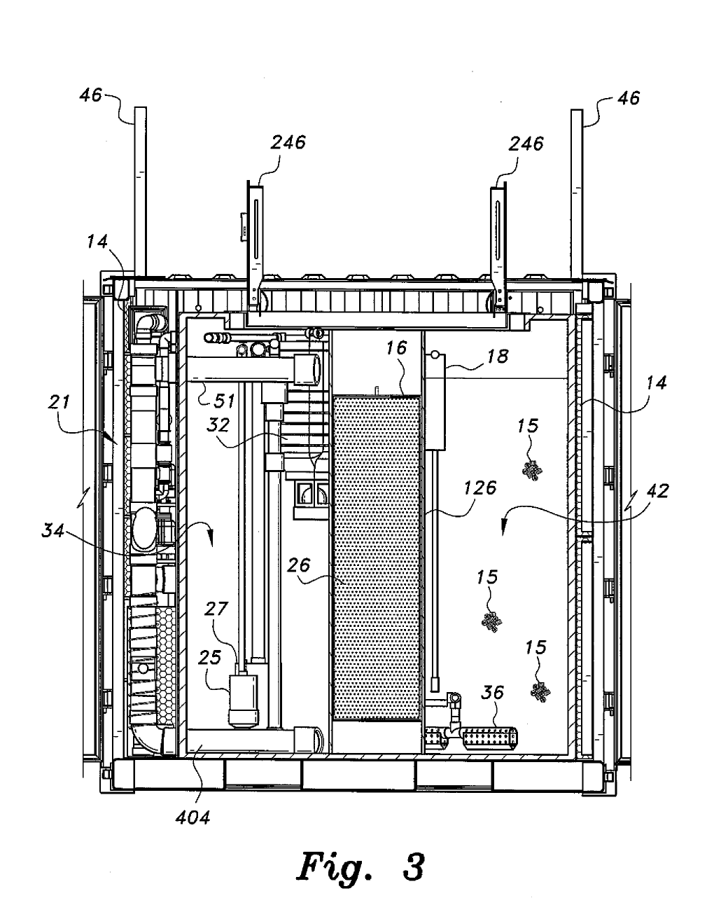

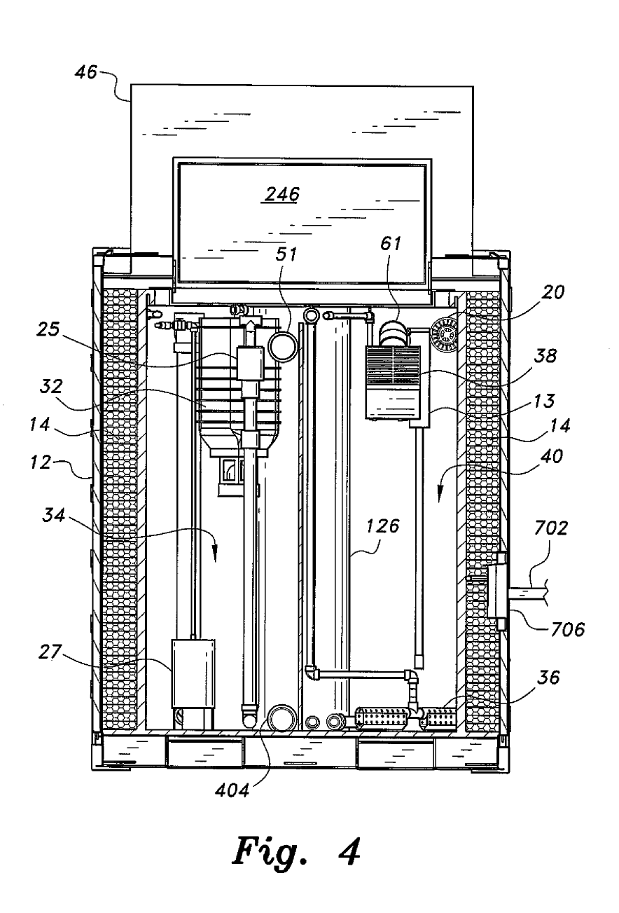

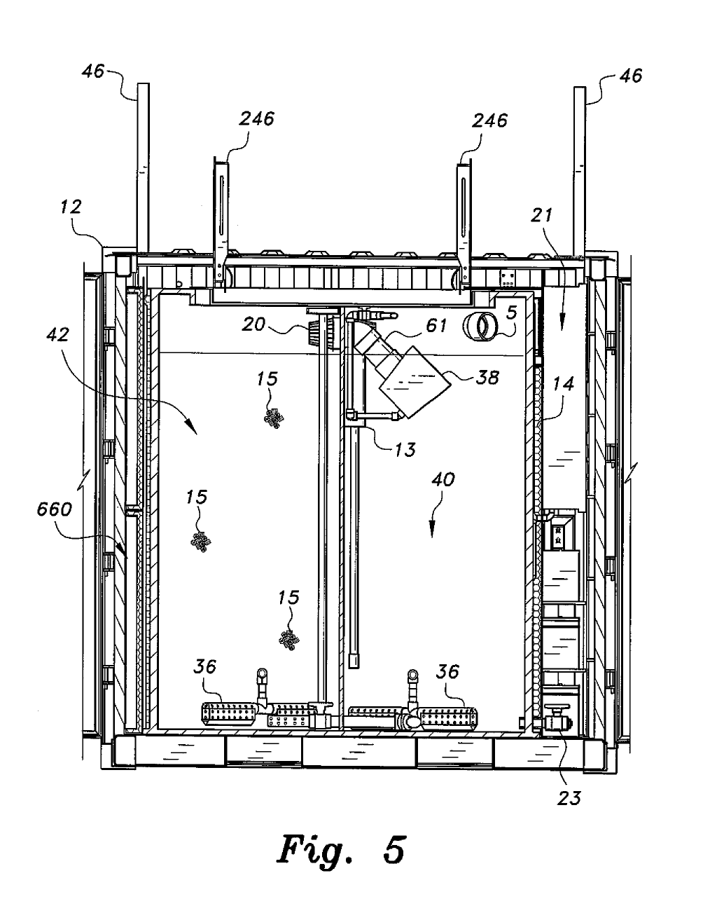

As shown in FIGS. 1-5, the rapid deployable packaged wastewater treatment system 10 includes a cylindrical plastic wastewater treatment vessel 44 and is disposed so that its axis extends from bottom to top inside a TRICON container 12. The TRICON container 12 has a pair of hinged access doors 28 on opposite sides of the container 12 for access to the control room 21 on one side and solar panel 200 storage on the other. The control room access doors have a fixed louvered vent and louvered exhaust fan installed within them to promote the movement of air within the control room 21 for moisture and heat control. The TRICON container 12 is modified to provide weather-tight, hinged hatch covers 46 disposed in the roof of the TRICON container 12 for access to the plastic wastewater treatment vessel 44. A bifurcated hinged hatch 246 is disposed beneath the weather tight hatch covers 46 at the top of the plastic wastewater treatment vessel 44 for access to the wastewater treatment equipment and vessel treatment chambers. Access to the top of TRICON Container 12 is provided by fold down steps located on the side of the TRICON container 12. When the TRICON container 12 is field deployed and leveled on the ground, the system operator will open both hatches 46 and 246 for access to the wastewater treatment vessel 44 and hinged access doors 28 for access to the control room 21.

Wastewater is pumped or gravity flows through the inlet port 5 into the Aerobic Pretreatment and Screening chamber 40. The Aerobic Pretreatment and Screening chamber 40 separates and retains solids, trash, grit, and fats, oils, and grease from the waste stream and begins the treatment process. A plurality of submersible coarse air diffusers 36 is disposed in the base of the Aerobic Pretreatment and Screening chamber 40 to provide aeration and mixing in the chamber. The aeration and mixing action work to break down organic and digestible solids such that digestion and treatment can commence immediately. An Aerated Bar Screen 38 located at the top water level retains inorganic solids that may be a part of the waste stream in the Aerobic Pretreatment and Screening chamber 40. Thus, the aerated bar screen 38 serves as a trash retention mechanism in the Aerobic Pretreatment and Screening chamber 40. The Aerated Bar Screen 38 is equipped with a small air diffuser that discharges air inside the bar screen continuously scouring the bar screen surface. The air scouring also agitates and breaks up any scum floating on the surface of the Aerobic Pretreatment and Screening chamber 40. Periodic pumping of the Aerobic Pretreatment and Screening chamber 40 is necessary to maintain a healthy sludge balance in the system and to remove indigestible solids.

A pH probe assembly 13 provides real time information to a Programmable Logic Controller (PLC) 860 regarding pH levels. The PLC 860 utilizes this information to provide real time information to the operator to ensure stable pH and alkalinity levels required by the microorganisms.

Pretreated Effluent from the Aerobic Pretreatment and Screening chamber 40 is discharged via a discharge pipe 61 through a media retention screen 20 to the Moving Bed Biological Reactor chamber (MBBR Bioreactor) 42, where advanced biological treatment begins.

The wastewater treatment system 10 reflects a combination of multiple technologies that utilize a number of different biological and mechanical wastewater treatment processes. The technology reflects a hybrid biological system that is rapidly started through the implementation of a bioseeding mechanism that is packaged and shipped as a part of the wastewater treatment system 10. In this regard, once the system is deployed in the field, unpacked, and assembled for field commissioning, the operator uses a bioseed package with specifically engineered microorganisms kick starting the biological treatment process at the outset. The engineered microorganisms reflect a conventional activated sludge biomass that will provide rapid startup of biological treatment in the first several days of wastewater operations. This is followed by higher order attached growth microorganisms that bind themselves to the integral fixed film media that is a primary treatment function within the MBBR Bioreactor 42. In this regard, the activated sludge treatment system transforms to a higher order fixed film treatment system that is more robust and compact and can address highly fluctuating flow rates respective of influent flows and influent wastewater strength concentrations.

Free-floating plastic media 15 disposed in the MBBR bioreactor 42 serves as the fixed film promoting a biological film (biofilm) to form and thrive thereon, wherein a fixed film biological treatment process provides advanced digestion of organics in contact with the film. The biofilm utilizes oxygen from the aeration system and organic food sources from the pretreated influent wastewater to complete the treatment process. This biofilm includes microorganisms which derive their energy from the incoming waste stream. As such, these microorganisms consume the available organic load and uptake nutrients that are part of the incoming waste stream to build cellular mass as part of the robust biofilm. In this regard, the wastewater treatment system can consume approximately ninety-nine percent of the incoming waste stream and incorporate it in the cellular biomass as part of the biofilm attached to the MBBR media. The result is the production and ultimate discharge of an extremely high quality effluent that possesses very little solids and/or residual BOD. Studies and practical experience with this technology indicates that this biofilm is the most robust and readily adaptable form of biological treatment available today. It is estimated that the waste generated from this system will be substantially less than ten percent of the overall incoming organic mass load. It is estimated that on a six-month operational cycle at a full operational capacity of 3,000 GPD, the wastewater system will only generate approximately 50 gallons of waste biomass and/or organic indigestible solids that are part of the incoming waste stream. This volume is substantially less than conventional activated sludge treatment systems. This reduction in solids will permit a substantial reduction of solid waste disposal.

Media retention screens 20 disposed in the MBBR bioreactor 42 retain the free-floating plastic media 15 in the MBBR bioreactor 42 and are specifically sized and placed in a configuration that prevents media transport to upstream or downstream treatment chambers.

A plurality of submersible coarse air diffusers 36 is disposed in the base of the MBBR bioreactor 42 to provide aeration and mixing in the chamber.

A redundant electrical linear air pump assembly 22 pressurizes air and injects the pressurized air via air supply line 100 and the coarse air diffusers 36 into both the Aerobic Pretreatment and Screening chamber 40 and MBBR Bioreactor 42. A PLC 860 controls the operation of the linear air pump assembly 22 and can be set to turn the linear air pump assembly 22 on and off at adjustable timed intervals if nitrogen reduction is required of the system 10. By turning the aeration on and off to the treatment system 10, the microorganisms will naturally change their metabolism to survive in an oxygen depleted environment. During the oxygen depleted cycle, the microorganisms cleave available oxygen molecules from nitrate and nitrite compounds present in the treated waste water. This biological metabolic process yields nitrogen gas, which naturally off-gasses to the atmosphere thus removing nitrogen from the waste stream.

The aerobic biological treatment processes utilize the air driven by a single linear air pump 22. The redundant linear air pump serves as a backup should failure occur to the primary and as an energy dump should the power generated by the alternative energy sources be greater than the demand of the wastewater treatment system 10.

The linear air pump assembly 22 provides the necessary air supply to a positive displacement air lift Return Activated Sludge (RAS) pump 27 that has no internal moving parts and is comprised completely of plastic. The RAS pump 27 is located in the secondary clarifier 34 and assists in providing secondary clarification of the highly treated wastewater. The RAS pump 27 returns settled biomass and any residual solids to the pretreatment and screening chamber 40 for continued treatment and enhanced digestion. The linear air pump assembly 22 also provides the necessary air supply to a scum removal assembly 25 that also utilizes a positive displacement air lift pump as part of the assembly and has no internal moving parts and is comprised completely of plastic. The scum removal assembly 25 is located in the secondary clarifier 34 and removes scum from the surface of the water and returns the scum to the pretreatment and screening chamber 40 for continued treatment and enhanced digestion. By using positive displacement air pumps, it is possible to eliminate costly and maintenance intensive submersible electric pumps. The pump rates of the RAS pump 27 and Scum Removal Assembly 25 are easily adjusted by simple independent diaphragm valves installed in the airlines to each.

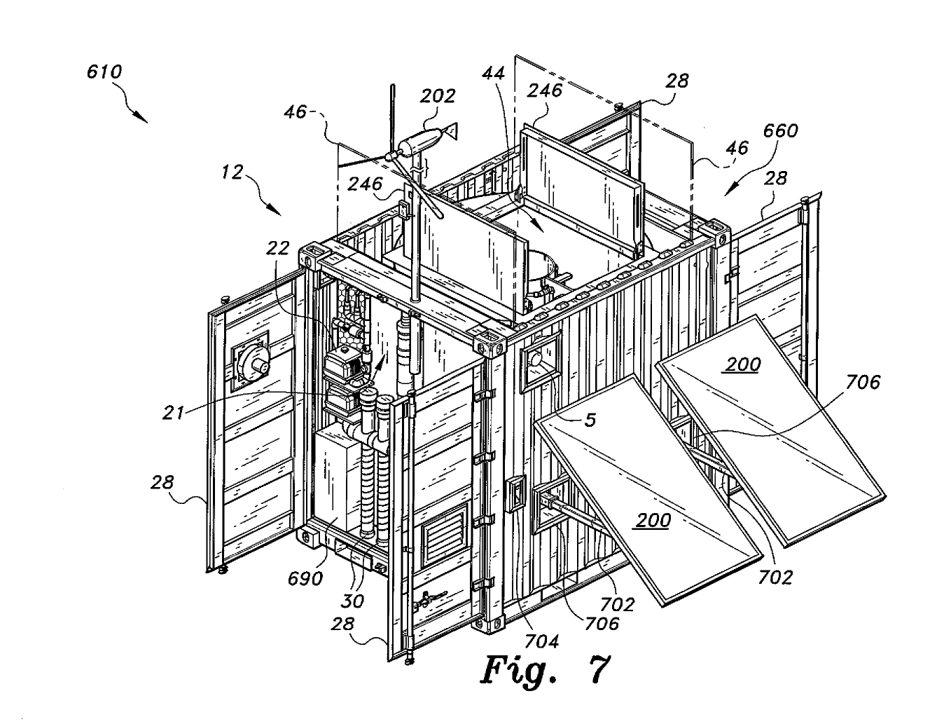

An Oxidation Reduction Potential (ORP) probe 18 provides real time information to PLC 860 regarding dissolved oxygen levels and wastewater temperatures. PLC 860 utilizes this information to assist in optimizing treatment efficiency by reducing energy consumption automatically via controlling ON-OFF functionality of, for example, the linear air pump 22 (shown in FIG. 7).

After the MBBR treatment, the treated wastewater flows by gravity through a media retention screen 20 connected to port 62 which feeds Secondary Clarifier chamber 34 for continued treatment. In the secondary clarifier chamber 34, sloughed biofilm discharged from the plastic fixed film media 15 combined with free floating biomass settles by gravity to the bottom of the Secondary Clarifier chamber 34. Positive displacement air lift RAS pump 27 pumps concentrated sloughed biofilm and free floating biomass back to the Aerobic Pretreatment and Screening chamber 40 for continued treatment and enhanced digestion.

The highly treated and clarified wastewater of the secondary clarifier chamber 34 then gravity flows through a coarse screen Effluent Filter 32 (equipped with a high water alarm), where any floating scum or large biomass floc is retained in the Secondary Clarifier Chamber 34. After passing through the coarse screen effluent filter 32, the treated secondary effluent gravity flows through a submerged media polishing filter 26 disposed in the center of the treatment vessel 44 for final biological treatment and polishing. The media polishing filter 26 comprises small light weight polystyrene beads or other suitable filter material, which form the media polishing filter 26. The filter media is housed in easily removable plastic netted sacks inserted into an approximately 18-inch diameter cylindrical filter housing 126 located in the center of the treatment unit in coaxial alignment with the treatment vessel 44. The treated secondary effluent is evenly spread across the top of the media polishing filter 26 by way of a removable flow distribution manifold 17 and a perforated grate 16 and gravity flows to discharge at the base of the cylindrical filter housing 126 through the media polishing filter 26, where a secondary biofilm forms on the media filter 26 to provide advanced secondary treatment and polishing. Once flow reaches the bottom of the media polishing filter 26, the filtered water enters a bottom outlet port 404 that conveys the water back up and through a discharge outlet pathway 204 by hydraulic principles.

Post aeration of the treated effluent is achieved by a combination of cascade aeration and trickling aeration. The treated effluent cascades down from the flow distribution manifold 17 onto the perforated grate 16 which creates a splash zone where the water is exposed to the atmospheric air. This aeration action is similar to a flowing stream. The treated effluent is then further aerated as it trickles through the un-submerged portion of the media filter 26.

After discharge from the discharge outlet pathway 204 of the media polishing filter 26, the highly treated water flows by gravity through a Flow Meter 35 and a duplex Ultraviolet Light disinfection system 30. The UV disinfection system 30 includes two small UV light assemblies installed in series for redundancy. Ultraviolet light from the disinfection system 30 sterilizes the final effluent by rupturing viral and bacteriological membranes rendering them inert and harmless. The flow meter 35 provides real time flow information that is continuously logged by the PLC 860. The PLC 860utilizes the flow information to assist in optimizing treatment efficiency by reducing energy consumption automatically via controlling ON-OFF functionality of the UV disinfection system 30 when there are no flows to be disinfected. After disinfection, the extremely high quality effluent gravity flows through a final discharge outlet port 224 by way of a camlock connection, where the effluent can be accepted by the local environment.

There are additional unique features of the wastewater system 10 provided in the control room 21. An emergency highwater overflow 51 from the media polishing filter 26 is provided and connected to the vertical stand pipe 53. In the event of a backup of the media filter 26 the treated secondary effluent gravity flows through the high water overflow to the UV disinfection system 30. A cleanout 50 is provided in the vertical section of the discharge outlet pathway 204 in the control room 21 to permit access to the discharge piping in the event of an emergency backup. An air vent 52 is provided in the control room 21 to vent the wastewater treatment vessel 44. The high water overflow piping additionally serves as the air ventilation piping. Electric heat tracing insulated wire 57 is utilized on the vertical section of the discharge outlet pathway 204 and UV disinfection units 30 to provide heat to the standing water during non-flow conditions with freezing temperatures. The heat tracing wire 57 is activated by a thermistor in the control room 21 which signals the PLC 860 when the temperature in the control room 21 reaches a preset low temperature.

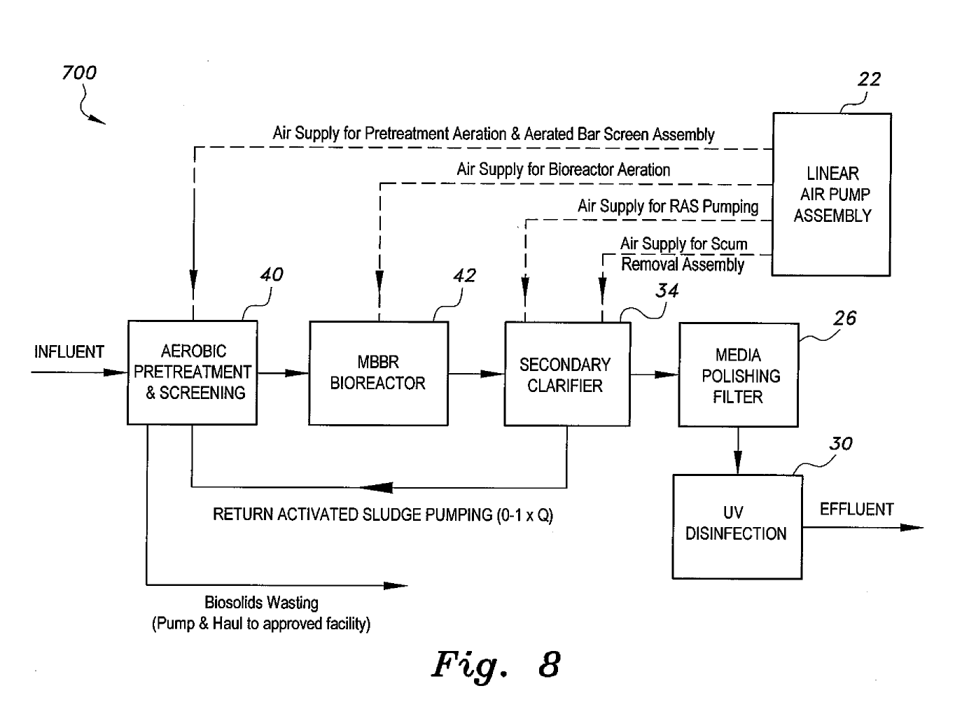

The system flow process diagram 700 of FIG. 8 summarizes the upstream-to-downstream flow of the system processes discussed above.

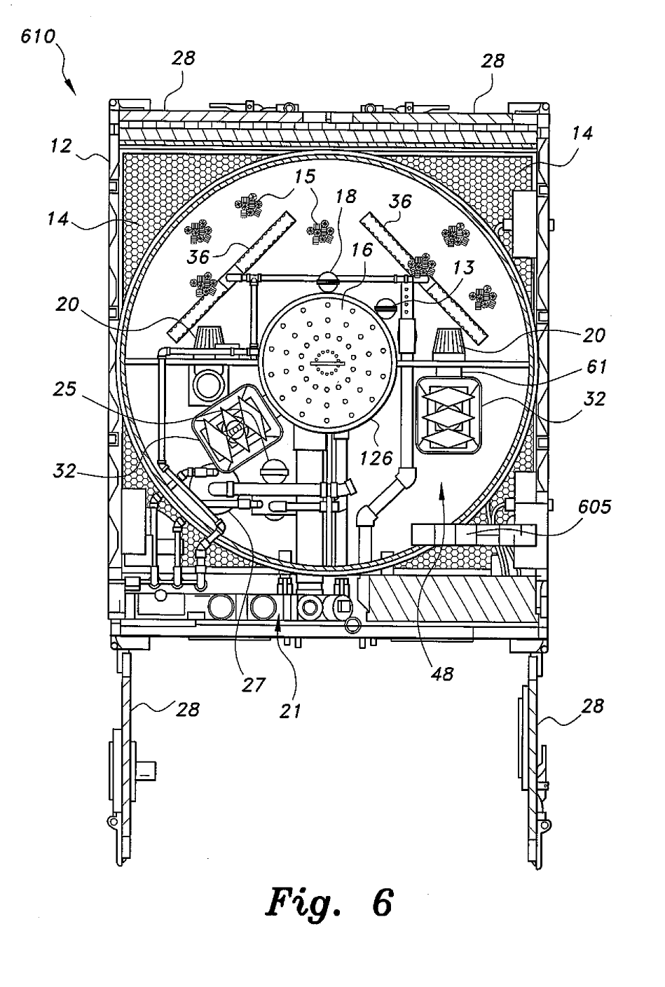

Comparing the embodiment 10 shown in FIG. 1 to the alternative embodiment 610 of FIG. 6 reveals that the aerobic pretreatment and screening chamber 40 of FIG. 1 is replaced by the primary clarifier chamber 48 shown in FIG. 6. The primary clarifier chamber 48 is utilized when there is no prescreening of the raw wastewater prior to discharge into the wastewater system 10. Wastewater is pumped or gravity flows through the inlet port 605 into the primary clarifier chamber 48. The primary clarifier chamber 48 separates and retains gross solids, trash, grit, and fats, oils, and grease from the waste stream and begins the treatment process anaerobically. A coarse screen Effluent Filter 32 (equipped with a high water alarm) serves as a trash retention mechanism and retains inorganic solids that may be a part of the waste stream in the primary clarifier chamber 48. Pretreated Effluent from the primary clarifier chamber 48 is discharged via discharge pipe 61 through media retention screen 20 to the MBBR Bioreactor 42, where advanced biological treatment begins. Periodic pumping of the primary clarifier chamber 48 is necessary to maintain a healthy sludge balance in the system and to remove indigestible solids and trash.

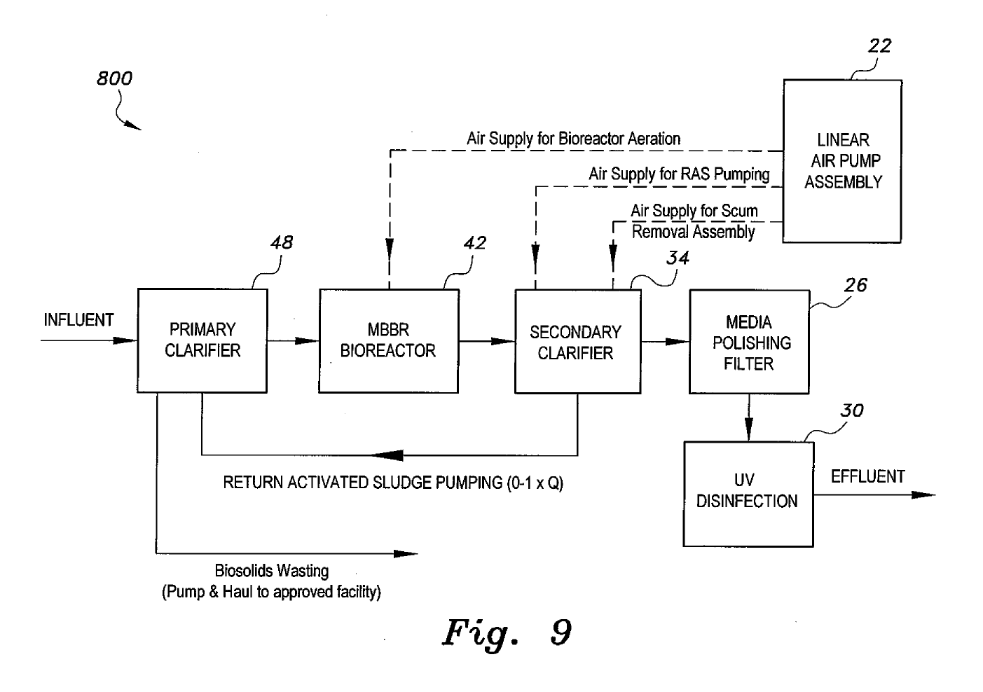

The system flow process diagram 800 of FIG. 9 summarizes the upstream-to-downstream flow of the system processes performed by the embodiment shown in FIG. 6.

The annular spaces between the treatment vessel 44 and the Tricon container 12 are filled solid with a flowable insulation 14, such as closed-cell urethane foam. This manufacturing process provides two primary components. The first component is that the foam helps to secure and stabilize the treatment vessel 44 inside the TRICON container 12. The second component is the fact that the thicknesses provided by the foam insulation 14 /reflects an approximate R-value of 70, and as such, makes the system deployable in harsh temperature climates. Based upon years of operational experience, freezing climates will reduce biological treatment efficiencies as the wastewater temperature approaches 32° F. Conversely, biological treatment performance will diminish greatly or transform to an unsustainable form of biology as wastewater temperatures climb above 110° F. The use of insulating foam around the treatment vessel 44 results in a well-insulated treatment unit within which microorganisms can survive in a wide range of climatic conditions.

The control room 21 houses, secures and provides operator access to the Control Panel 24 and PLC 860, linear air pumps 22, UV disinfection system 30, flow meter 35, backup battery stack 230, treatment system drain valves 23 and wind turbine system storage crate 690. Treatment system drain valves 23 are disposed at the floor of the control room 21 to permit the operator to drain each chamber of the treatment vessel 44. An LED courtesy light system 808 is also disposed inside the control room 21 to visually aid the operator during dark periods.

The system 10 is designed to operate using power from a number of power sources. Specifically the system is designed to run remotely using solar panels 200 installed on one side of the Tricon container 12 and/or a wind turbine 202 placed on the top of the Tricon container 12. Equipment for both alternative energy sources are shipped within the Tricon Container 12 and installed and made operational quickly in the field. The electrical system is designed such that it can also be operated using a local generator. A generator will provide power through a generator plug port 704 recessed in the side of the TRICON container 12. An automatic transfer switch installed within the control panel 24 monitors power for the system and automatically transfers power from the alternative energy systems to a grid supply power source, such as a local generator. In addition, during times when sunshine, wind or a local generator are unavailable, the system can function using power supplied from the charged back-up battery stack 230. The battery back-ups 230 can provide electrical operations of the system for approximately seventy-two hours without an external energy source input. The batteries are protected by a charge controller installed within the control panel 24. The charge controller is a voltage and/or current regulator that keeps the batteries from overcharging. It regulates the voltage and current coming from the solar panels and/or wind turbine systems going to the battery stack 230. Therefore, the system 10 can operate by utilizing energy from either the solar panel 200 and/or the wind turbine 202, the back-up battery stack 230, or from a grid supply power source, such as a generator. The combination of available power sources provides necessary energy redundancy that is crucial to sustained wastewater treatment operations.

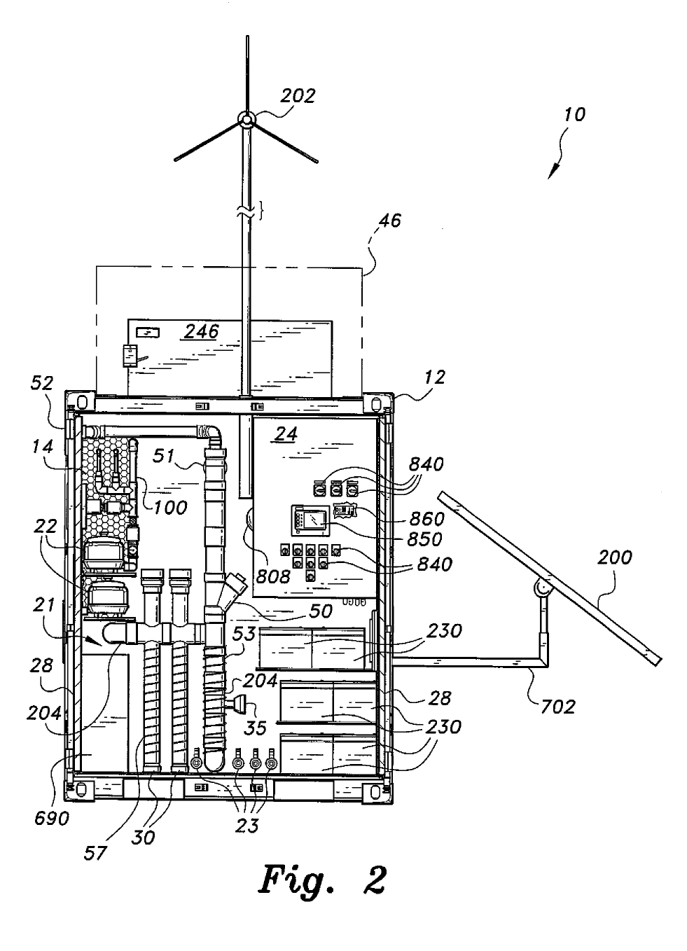

The two solar panels 200 are strategically housed within foam padded storage spaces for protection in the solar panel storage area 660 on the end of the Tricon container 12 opposite the control room 21 during shipping. Hinged access doors 28 provide access to the storage spaces. The structural support frames 702 for the solar panels 200 are housed in the annular space between the top of the plastic wastewater treatment vessel 44 and the weather-tight hatch 46 during shipping. As most clearly shown in FIG. 2, the structural support frames 702 for the solar panels 200 are L-shaped members with terminal pivotal connections to the solar panels 200. The solar panels are easily and quickly removed from the Tricon container 12, installed on the structural support frame 702 and put into operation as shown in FIG. 7.

The structural support frame 702 is easily inserted and pinned in place into structural weldments 706 in the side of the Tricon container 12 similar to a standard vehicle hitch assembly. The electrical connection for each solar panel is located in the structural weldment 706. Similarly the wind turbine 202 is housed within a foam padded storage crate 690 for protection in the control room 21 during shipment. The structural mast sections for the wind turbine are housed vertically adjacent to the solar panel storage spaces 660 during shipping. The wind turbine and mast sections are easily and quickly removed from the Tricon container 12, the mast sections pinned connected, the wind turbine mounted to the top of the mast and the system put into operation as shown in FIG. 7. The electrical connection for the wind turbine is located in one of the structural weldments 706. The solar panel storage spaces 660 and wind turbine masts are accessed by hinged access doors 28 on the opposite side of the Tricon container 12 from the control room 21.

The control panel 24 and all internal components comply with current Military and UL standards and specifications. The panel enclosure reflects the correct NEMA rating as deemed appropriate for the final design. The control panel 24 is equipped with a safety breaker, which has an access handle that disconnects main power to the control panel 24 when the front panel access door is opened. A fully functional Programmable Logic Controller (PLC) 860 disposed in the control panel 24 provides automatic operation of the wastewater treatment system 10. The PLC 860 includes a small LCD Human Machine Interface (HMI) display screen and keypad 850 to permit operator access to, monitoring of, and adjustment of system operational parameters. The PLC 860 processes and data-logs telemetry from the probes, sensors and meters to start and stop pumping, aeration and disinfection systems and to provide system alarm notification in the event of abnormal flows and wastewater characteristic or equipment failure events. The control panel 24 is equipped with a flashing red strobe light that illuminates during alarm conditions. The PLC 860 provides optional web-based Ethernet/Internet access for remote monitoring and operation of the system. The panel is also equipped with an optional autodialer. The autodialing function permits remote notification of an alarm condition. The panel is equipped with a convenience power plug that could be utilized in an emergency for communication power. When utilized the power plug switches all power to the system 10 off to allow the power from the alternative energy sources or backup battery stack to be used solely for communications. The control panel 24 also includes HOA (Manual-Off-Automatic) switches 840 for all equipment to permit the operator to manually control the system should a failure occur to the PLC 860. The control panel is also equipped with an automatic -power inverter to permit the operation of the 120-volt power components utilizing the power generated from the 24-volt solar panels 200 and/or wind turbine 202.

The present wastewater treatment technology described herein reflects a wastewater system design utilizing different but specific treatment processes and equipment. The design of this system is specifically engineered to reduce the amount of energy required to treat the wastewater stream. Conventional wastewater treatment processes are usually energy intensive to support treatment operations. The system 10 as designed minimizes electrical power requirements and reduces the number of internal mechanical components needed to process wastewater. The only significant power-consuming pieces of equipment are the linear air pump 22 and the UV disinfection system 30. Total power consumption at full operation of the linear air pump 22 is approximately 250 watts, The two small robust UV disinfection systems 30 each only consume a maximum of 30 watts of power. The overall power consumption for continuous full-system operation of the system 10 is approximately only 350 watts. Moreover, the treatment vessel 44 is structurally designed to permit a buried installation of the system 10 independent of the Tricon container 12.

It is to be understood that the present invention is not limited to the embodiments described above, but encompasses any and all embodiments within the scope of the following claims.

We claim:

1. A rapid deployable packaged wastewater treatment system, comprising:
a watertight, hollow, elongate, vertically disposed cylindrical tank made from plastic, the tank having a top and a hatch opening defined in the top;
an inlet pipe extending into the tank, the inlet pipe being adapted for admitting liquid into the tank;
an outlet pipe extending from the tank, the outlet pipe being adapted for discharging the liquid from the tank; and
partitions dividing the tank into first, second, third, and fourth vertically extending chambers, the second vertically extending chamber being a moving bed biological reactor (MBBR) Bioreactor chamber, the third vertically extending chamber being a secondary clarifier chamber, and the fourth vertically extending chamber being a media polishing filtration chamber, the inlet pipe directly feeding the first vertically extending chamber,

2. The wastewater treatment system according to claim 1, further comprising an access hatch door pivotally attached to the cylindrical tank hatch opening.

3. The wastewater treatment system according to claim 2, further comprising:
a housing having a substantially rectangular cross section, the housing enclosing the cylindrical tank, the housing having a side and at least two pivotally attached doors on the side of the housing;
foam insulation disposed in annular spaces between the plastic cylindrical tank and internal walls of the housing;
a hatch opening in a roof portion of the housing;
an access hatch door pivotally attached to the housing hatch opening;
a control room disposed inside the housing;
a control panel disposed inside the control room;
a programmable logic controller (PLC) disposed in the control panel, the PLC controlling electronic functions of the wastewater treatment system; and
at least one aeration blower disposed in the control room, the at least one aeration blower being controlled by the programmable logic controller, the aeration blower supplying air to be used in the first vertically extending chamber, the MBBR bioreactor, and the secondary clarifier chamber.

4. The wastewater treatment system according to claim 3, further comprising a UV disinfection unit disposed downstream from the media polishing filtration chamber, the UV disinfection unit being disposed in the control room, the UV disinfection unit accepting effluent and having means for destroying hazardous microbes in the effluent.

5. The wastewater treatment system according to claim 3, further comprising alternative energy sources, the alternative energy sources including solar panels, wind turbine and battery stack backup stored within the control room and connected to power plugs disposed on the housing, the alternative energy sources providing power to the wastewater treatment system when a local power source is unavailable.

6. The wastewater treatment system according to claim 3, wherein said first vertically extending chamber is an aerobic pretreatment and screening chamber.

7. The wastewater treatment system according to claim 3, wherein said first vertically extending chamber is a primary clarifier chamber.

8. The wastewater treatment system according to claim 7, further comprising a discharge pipe extending from the first vertically extending chamber to the second vertically extending chamber to discharge effluent from the first vertically extending chamber into the second vertically extending chamber.

9. The wastewater treatment system according to claim 8, further comprising a media retention screen attached to the discharge pipe, the first chamber effluent flowing through the media retention screen into the second vertically extending chamber.

10. The wastewater treatment system according to claim 9, further comprising a bioseed package disposed in the second vertically extending chamber.

11. The wastewater treatment system according to claim 10, further comprising fixed film media disposed in the second vertically extending chamber.

12. The wastewater treatment system according to claim 11, further comprising second chamber media retention screens disposed in the second vertically extending chamber, the second chamber media retention screens retaining the fixed film media in the second vertically extending chamber, thereby preventing upstream or downstream transport of the fixed film media.

13. The wastewater treatment system according to claim 12, further comprising:
submersible coarse air diffusers disposed in a base portion of the second vertically extending chamber; and
an air supply line connected to the at least one aeration blower, the air supply line in combination with the air diffusers providing aeration and mixing inside the second vertically extending chamber at timed intervals determined by the PLC.

14. The wastewater treatment system according to claim 13, further comprising a Return Activated Sludge (RAS) pump disposed in the secondary clarifier, the RAS pump returning settled biomass and any residual solids to the first vertically extending chamber.

15. The wastewater treatment system according to claim 14, further comprising a scum removal assembly disposed in the secondary clarifier, the at least one aeration blower in combination with the air supply line providing necessary air supply to the scum removal assembly, the scum removal assembly removing scum from the surface of the water and returning the scum to the first vertically extending chamber.

16. The wastewater treatment system according to claim 15, further comprising an Oxidation Reduction Potential (ORP) probe disposed in the wastewater treatment system for providing real time information to the PLC regarding dissolved oxygen levels and wastewater temperatures, the PLC having means for utilizing the real time information to reduce energy consumption automatically via controlling ON-OFF functionality of the at least one aeration blower.

17. The wastewater treatment system according to claim 16, further comprising a port and media retention screen disposed between the second vertically extending chamber and the secondary clarifier, effluent from the second vertically extending chamber gravity flowing through the port and media retention screen into the secondary clarifier.

18. The wastewater treatment system according to claim 17, further comprising:
a course screen effluent filter disposed in the secondary clarifier chamber, highly treated fluid flowing by gravity through the course screen effluent filter and into the media polishing filtration chamber;
submerged media polishing filter disposed in the media polishing filtration chamber;
a discharge outlet pathway disposed in the media polishing filtration chamber and extending out from the media polishing filtration chamber;
an outlet port disposed at the bottom of the submerged media polishing filter for conveying fluid flowing through the submerged media polishing filter back up and through the discharge outlet pathway and into the UV disinfection unit; and
a flow distribution manifold combined with a perforated grate, the combination evenly spreading treated secondary effluent across the top of the media polishing filter.
